(19) United States
(12) Patent Application Publication
(10) Pub. No.: US 2022/0160565 A1
(43) Pub. Date: May 26, 2022

(54) Hyperbaric Chamber Designed for Transport through a Narrow Opening

(71) Applicant: Frederick E. Ryder, Waddell, AZ (US)

(72) Inventor: Frederick E. Ryder, Waddell, AZ (US)

(21) Appl. No.: 17/176,531

(22) Filed: Feb. 16, 2021

Related U.S. Application Data
(60) Provisional application No. 63/118,479, filed on Nov. 25, 2020.

(51) Int. Cl. A61G 10/02

(52) U.S. Cl. CPC A61G 10/026

(57) ABSTRACT

The embodied invention is a hyperbaric chamber that is designed to fit through a narrower dimension, such as a doorway, window, garage, or hallway by utilizing a multi-section design. The preferred embodiment is a split chamber design that allows two or three sections to be moved by caster wheels, either on the legs with casters or on a moving cart. The width of the separate sections is designed to fit through a 34″ doorway, and then are readily bolted together to a desirable length. Additionally, the flanges design that connect the individual vessel parts together are designed to provide the pressure needed at a very low weight.

### CROSS REFERENCE TO RELATED APPLICATIONS

This application claims the benefit of U.S. provisional application No. 63/118,479 filed on Nov. 25, 2020. The entire provisional application is incorporated by reference herein.

### STATEMENT REGARDING FEDERALLY SPONSORED RESEARCH OR DEVELOPMENT

Not applicable.

### BACKGROUND OF THE INVENTION

### (1) Field of the Invention

This invention is directed toward hyperbaric chambers that are used in oxygen therapy.

### (2) Description of Related Art

Hyperbaric oxygen therapy involves breathing pure oxygen in a pressurized environment. Hyperbaric oxygen therapy is a well-established treatment for a variety of illnesses and aliments, such as therapy include serious infections, air bubbles in blood vessels, and tissue repair.

In a hyperbaric oxygen therapy chamber, the air pressure is increased from two to three times higher than ambient air pressure. At this elevated pressure, a patient's lungs can exchange much more oxygen than would be possible breathing pure oxygen at normal air pressure. Better oxygenated blood carries this additional oxygen throughout the body, which helps fight bacteria and stimulates the release of growth factor substances and stem cells, to improve healing. For most conditions, hyperbaric oxygen therapy lasts approximately two hours. Additionally, oxygen concentrators are often used while the patient is in the hyperbaric chamber to enhance oxygen absorption.

Hyperbaric oxygen therapy may be used to treat the following medical conditions including: Severe anemia, brain abscess, Bubbles of air in your blood vessels (arterial gas embolism), burns, carbon monoxide poisoning, crushing injury, sudden deafness, decompression sickness, gangrene, infection of skin or bone that causes tissue death, nonhealing wounds, such as a diabetic foot ulcer, radiation injury, skin graft, brain injury, and vision loss.

One difficulty with current designs of hyperbaric chambers is that they are very large in diameter and length; and are not easily installed in a facility. They are heavy, weighting approximately 1200-1400 lbs. for a typical commercial chamber that is 64″ long and 42″ in diameter. The weight and diameter make it impossible to maneuver through 36 inch doorways, that often only allow a 34″ opening without removing the door. Potential installation in many non-hospital medical facilities is difficult as it is not a matter of removing a door or a window.

Consequently, there is need for the chamber to be reduced in size and weight for movement through a variety of facilities and provide easy assembly without overhead lifting equipment. Many medical facilities utilize existing commercial properties which are not designed to maneuver heavy and long equipment. For example, elevators are often not available when installing a chamber on a second floor.

Flange designs for piping, such as 150#, are too heavy for practical use in transporting. A single 42″ diameter slip on flange weighs 234 lbs. Since two flanges are needed for sealing, this would add nearly 470 lbs. to the total weight.

The design must also be weight improved so minimize the overall weight. It is desirable that the split chamber is separable into manageable sections that are easily moved manually throughout a facility without levers, winches, or pullies. Transportation and movement through a facility without use of a complicated moving truck or cart is most desirable, and the chamber parts are preferably pushed into position with little trouble for a one or two man crew.

In the art, to get around transportation to a particular room in a facility, commercially available hyperbaric chambers have been produced with a smaller diameter that will fit through door openings, such as 34″ wide or less. But this is less desirable due to claustrophobia by a patient in a smaller chamber, among other patient concerns.

It is highly desirable to have a larger diameter hyperbaric chamber with a standard length that provides easy installation and improved patient comfort during a one or two hour procedure. Patients prefer chambers that allow them to sleep, read, listen to music, or connect to the internet. Such chambers are longer and wider than is practical to maneuver in many non-hospital settings.

### BRIEF STATEMENT OF THE INVENTION

The embodied invention is a hyperbaric chamber that is designed to fit through a narrower dimension, such as a doorway, window, garage, or hallway by utilizing a multi-section design. The preferred embodiment is a split chamber design that allows two or three sections to be moved by caster wheels, either on the legs with casters or on a moving cart. The width of the separate sections is designed to fit through a 36″ wide doorway, and then are readily bolted together to a desirable length. Additionally, the thinner flange-thicker rubber seal design that connects the individual vessel parts together provides the pressure needed at a very low weight.

### BRIEF DESCRIPTION OF THE FIGURES

FIG. 1 shows a hyperbaric chamber with a vertical flange pair.

FIG. 2 shows a hyperbaric chamber with an additional center section.

FIG. 3 is a detail view of the thin flange-thick Buna seal design.

FIG. 4 shows the hyperbaric chamber of FIG. 1 with the sections separated.

### DETAILED DESCRIPTION OF THE INVENTION

The embodied invention is a hyperbaric chamber design that provides an improved and lower cost installation by creating the chamber in two parts which are assembled together. Either a horizontal or a vertical oriented flange is welded or otherwise joined to each part of the chamber. Preferably, the chamber is only broken down into two parts and is capable of withstanding 2 atmospheres of pressure.

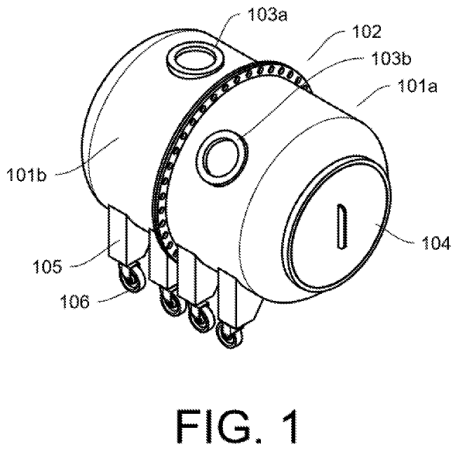

In FIG. 1, a tubular shaped hyperbaric chamber is split into an entry section 101a and a back end section 101b, and is supported by legs 105. A pair of vertical oriented flanges 102 with bolt holes are located substantially in the middle of the chamber. The flanges and cylindrical body are capable of about 40 psi air pressure without leaking. For any particular installation, the hyperbolic chamber is maneuvered into position and the flange pair is bolted together. An entry door with handle 104 is used to provide patient access to the inside of the hyperbaric chamber. Two circular viewing ports 103a,b are shown, although any number of viewing ports and shapes could be added. A plurality of casters 106 are used to move/locate/the two sections around. A thick rubber gasket between ⅛ inches to ½ inches is located between the flanges.

Other important connections, such as oxygen and air pressurizing equipment are not shown in any figure.

For ease of transport, a specialized transportation cart can be employed with supports for the weight of the chamber, and also include tabs, supports, and clamps that will facilitate the movement through hallways and door openings of a building. The smaller design of FIG. 1 is preferably transported by its leg casters and wheeled into position.

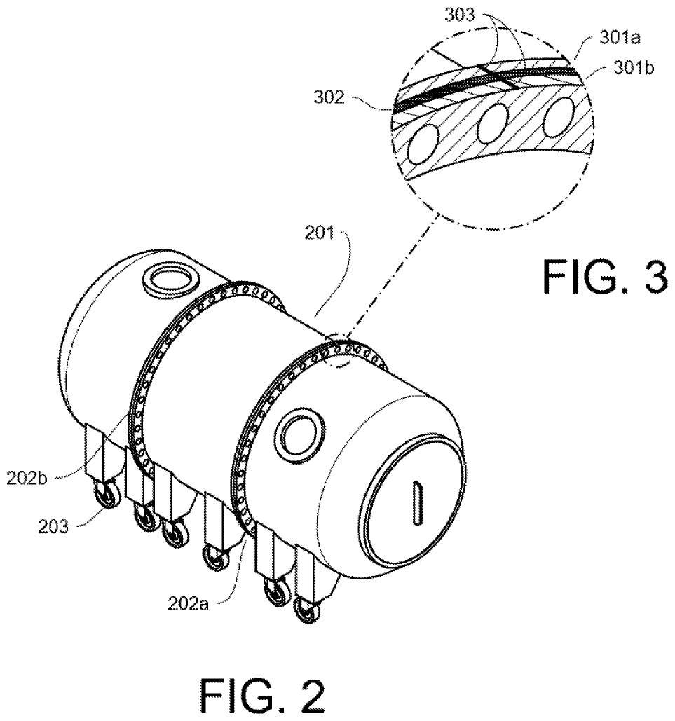

FIG. 2 shows a hyperbaric chamber with an additional center section 201 that has been added to elongate the axial chamber length. In this case, the hyperbaric chamber is broken into three sections, which allow a longer chamber to be easily transported. From a clinical standpoint, this provides a greater length for patient comfort by allowing the patient to completely lie down. Similar to FIG. 1, the chamber is split into three sections by a pair of flanges 202a,b with bolt holes. A plurality of casters 203 are used to move/locate/the three sections around. Again, each section length is less than 36 inches.

In FIG. 3, each welded slip on flange 301a,b is ¾″ thick, and the rubber gasket 302 between a flange pair is typically ½″ thick when uncompressed. More broadly speaking, the gasket is preferably ⅛ to ½ inches thick uncompressed. A punch or scribe mark 303 is added to the top of the flanges to aid in field assembly. About ¾ inch high strength bolts are preferably used for connecting the flange pair.

In general, the pressure test factor for typical 30 psi chamber pressure is 30 psi×1.4=39 psi, and a soapy water test is used to inspect for leaks around the assembly. The ½″ thick rubber gasket (such as Buna-N) is used for sealing to provide improved tolerance of alignments.

Preferably, the flange material is a high strength steel such as ASTM A516 Grade 70 Plate (also called ASME SA516-70) with a tensile strength of at least 70,000 psi. The flange is preferably about ¾″ thick with an OD that is 4″ larger than the ID. For example, a 42″ diameter chamber will have a slip on flange with an ID of 42″ and an OD about 46″.

After initial assembly in the assembly plant, a center mark 303 is stamped on the top flange to aid in alignment and assembly. Bolting the sections by utilizing a suitable bolt hole alignment tool, such as an adjustable Spud Wrench (includes a tapered shaft), simplifies alignment and bolting during assembly. Due to the thick gasket, the assembly of the flanges do not have to be carefully aligned.

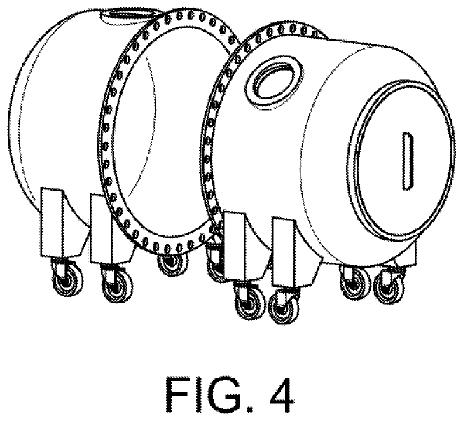

When transporting the chamber sections, the caster wheels are used for transport and maneuvering into position (see FIG. 4). Alternately, a cart is built for the purpose of stabilizing and moving the sections. Simple aluminum ramps are used to overcome minor floor bumps or door threshold/still. A wide variety of thresholds, steps, floor cracks etc. will need to be overcome when installing a new hyperbaric chamber in a medical facility.

In an alternate embodiment, a short cart moves a chamber section, and the chamber section can be placed in position by removing the cart. In this case, strategic placement of lifting jacks can lift the section off a cart, the cart is removed, and then the sections lowered into place. In another alternate embodiment, a combination of chamber leg casters and a transportation cart is used.

By utilizing a split design, the pushing force needed to overcome a stair riser at an office entry is reduced as well, and a ramp with a low incline angle is utilized for pushing over higher obstacles, such as a front door step.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A multi-section hyperbaric chamber designed for convenient transportation and assembly through narrow openings comprising:
A) an enclosed tubular shaped chamber divided into an entry section and a back section,
B) said entry section and said back section are connected together by a pair of flanges, said flanges having a plurality of bolt holes with bolts,
C) a gasket made from rubber positioned between said pair of flanges, said gasket is between ⅛ and ½ inches thick inclusive,
D) said flanges having a plane that is oriented perpendicular to a lengthwise axis of said chamber,
E) said flanges made from steel with at least 70,000 psi tensile strength,
F) said flanges are substantially ¾″ thick,
G) a plurality of support legs, said support legs positioned to stably support said entry section and stably support said back section,
H) a plurality of casters, wherein each said support leg is connected to a caster,
I) said entry section and said back section each having an axial length less than 36 inches, and
J) whereby
a) said entry section and said back section are maneuverable by use of said casters,
b) said entry section and said back end section are separately maneuverable through an opening less than 36 inches wide, and
c) said chamber maintains a hyperbaric pressure when said entry section and said back section are connected together.

2. The multi-section hyperbaric chamber according to claim 1 further comprising a punch mark at the top of each said flange to indicate the top of each said flange.

3. A multi-section hyperbaric chamber designed for convenient transportation and assembly through narrow openings comprising:
A) an enclosed tubular shaped chamber divided into an entry section, a center section, and a back section,
B) a plurality of flanges,
C) said entry section and said center section are connected by a pair of said flanges,
D) said center section and said back section are connected by a pair of said flanges,
E) said flanges having a plurality of bolt holes with bolts,
F) a gasket made from rubber positioned between each said flange pair, said gasket is between ⅛ and ½ inches thick inclusive,
G) said flanges having a plane that is oriented perpendicular to a lengthwise axis of said chamber,
H) said flanges are made from steel with at least 70,000 psi tensile strength,
I) said flanges are substantially ¾″ thick,
J) a plurality of support legs, said support legs positioned to stably support said entry section, stably support said center section, and stably support said back section,
K) a plurality of casters, wherein each said support leg is connected to a caster,
L) said entry section, said center section, and said back section each having an axial length less than 36 inches, and
M) whereby
a) said entry section, said center section, and said back section are maneuverable by use of said casters,
b) said entry section, said center section, and said back section are separately maneuverable through an opening less than 36 inches wide,
c) said chamber maintains a hyperbaric pressure when said entry section, said center section, and said back section are connected together.

4. The multi-section hyperbaric chamber according to claim 3 further comprising a punch mark at the top of each said flange to indicate the top of each said flange.
